(19) United States
(12) Patent Application Publication
(10) Pub. No.: US 2009/0164136 A1
(43) Pub. Date: Jun. 25, 2009

(54) Integrated and/or Automated Device for Locating and/or Being Able To Trace Medical or Veterinary Primary Sample Sampling Containers

(76) Inventor: Henri Joubert, Condat Sur Vienne (FR)

Correspondence Address: NIXON & VANDERHYE, PC, 901 NORTH GLEBE ROAD, 11TH FLOOR, ARLINGTON, VA, 22203, US

(21) Appl. No.: 12/084,485

(22) PCT Filed: Oct. 31, 2006
(86) PCT No.: PCT/FR2006/002436

§ 371 Date: May 2, 2008

(30) Foreign Application Priority Data
Nov. 2, 2005 (FR) 0511163

(51) Int. Cl. G01N 35/00

(52) U.S. Cl. 702/22

(57) ABSTRACT

The invention relates to an integrated and/or automated device for locating and/or being able to trace medical or veterinary primary sample sampling containers (1), comprising at least one containers holder (2) provided with a number of seats for each receiving one of said containers (1), each of the containers (1) being provided with a barcode (3), characterized in that it at least comprises means for; detecting (4) the presence of these containers in the corresponding seat; reading (5) the barcodes (3) of the containers (1); capturing references of the sample contained in the containers (1); storing (7) read and/or captured information; correlating (8) read and captured information for a same container (1); controlling (9) for managing and driving the detecting means (4), reading means (5), capturing means (6), storing means (7) and/or correlating means (8), and; visualizing (10).

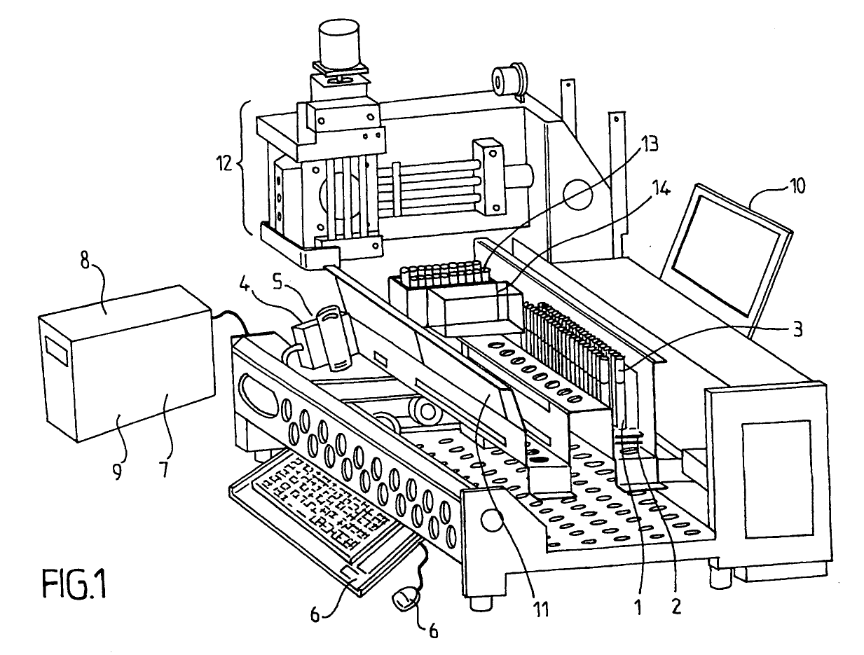

The present invention relates generally to the identification and locating of specimen holders for medical or veterinary primary samples and concerns in particular an integrated and/or automated device for locating and/or tracking these holders.

In the field of medical or veterinary analysis, biological samples, for example blood samples, taken from a patient are known as primary samples and are generally put into specimen holders, also known as primary holders when these specimens are prepared immediately after the sample is taken.

More particularly in this context, the invention relates to medical or veterinary primary samples arranged in at least one holder rack provided with a plurality of receptacles for receiving in each case one of said holders, the latter being provided with a barcode.

Once placed in the specimen holders, the samples are referenced with labels bearing a barcode in each case corresponding to a tube and which when read, by correlation using appropriate software, allows the patient to be identified and/or analyses to be carried out.

Depending on the analyses to be carried out, these samples are sometimes divided up into so-called secondary samples and in each case put into a specimen holder also known as a secondary holder.

In the context of preparing these secondary samples, the relevant primary sample is generally subjected to centrifuging followed by manually pipetting, for example, the supernatant. The material and the amount pipetted constitute the secondary sample.

The specimen holders, both primary and secondary, are placed into holder racks so as to establish a collection of samples which are then analyzed holder rack by holder rack.

Depending on the analysis to be carried out and on the nature of the pathology to be detected, the holders are likewise sometimes kept for a set amount of time in a serum bank in order to repeat an analysis if necessary, or in order to carry out another type of analysis.

Once the analysis has been carried out and/or the expiration date or the storage limit have been reached, the relevant holders are removed from the holder racks and/or the serum bank with a view to putting them into containers before destroying the samples.

The holder racks are sometimes also referenced by a label in the form of a barcode as is the container intended to receive the samples to be destroyed.

While all these operations are being carried out, the generation of new barcodes on the various constituent elements of the serum bank (primary samples, secondary samples, holder rack, containers, etc.) is liable to create a source of errors as far as being able to trace the samples is concerned. It is thus necessary to provide, starting with the identification of the patient, a chain that allows the correlation of the different barcodes produced from the primary sample.

These operations are involved and require a large amount of time to carry out as well as the monopolizing of a technician to carry out all these operations.

The inventors have developed, as the subject of the present invention, an integrated and/or automated device for locating and/or tracking specimen holders for medical or veterinary primary samples which alleviates these drawbacks, particularly by making each sample traceable while guaranteeing optimal security and reliability.

The device comprises at least one holder rack provided with a plurality of receptacles for receiving in each case one of said holders, each of said holders being provided with a barcode.

The device according to the present invention is characterized in that it additionally has at least the following means:
means for detecting the presence of said holders in the corresponding receptacle;
means for reading the barcodes of the holders;
means for logging the references of the sample contained in the holders;
means for storing the information read and/or logged in a memory;
means for correlating the information read and logged for an identical holder;
means for controlling the management and running of the detection means, the reading means, the logging means, the memory means and/or the correlating means; and
display means.

These particular measures thus make it possible to work with a holder rack which is not entirely full, i.e. in which some of the receptacles can be vacant.

The device according to the invention also makes it possible to read the barcode of each holder and, by using the logging means, to allocate to the read barcode the details of each patient, the references of the analysis to be carried out, and the expiration date of the specimen.

The information read and logged is thus correlated as a whole and can be saved in storage means of the device according to the invention.

The device according to the invention further has means for managing and running all the means in use.

The display means provided for the device make it possible, furthermore, to monitor at any time the data read and logged, its correlations, and the progress of its archiving.

Preferably, the receptacles of each holder rack are advantageously arranged in at least one row.

The receptacles of a holder rack having more than one row are arranged in staggered rows facing the means for reading the barcodes.

Preferably and in order to be able to utilize existing barcode reading techniques, the means for reading the barcodes of the holders are arranged parallel to the holders and windows are formed such that reading can only take place at predetermined positions corresponding to said receptacles.

More particularly, the holder racks of the device according to the present invention can be moved and/or removed.

This feature makes it possible, furthermore, to set up a holder rack entirely or partially filled with holders outside the device according to the invention. Moreover, it is thus possible to take the holder rack out of the device once the archiving and logging operations are complete in order to proceed with analyzing the specimens contained in the holders and/or to place the holder rack in the serum bank.

The movability of the holder rack is useful, for example, for efficiently positioning the holders opposite the barcode readers.

In this particular context, the holder rack may have a barcode which references it and the correlation between the primary holders and the holder rack may be carried out by the logging means, the memory means and/or the correlating means of said device.

More particularly in this context, the device according to the present invention could also have, if need be, a dedicated barcode reader for reading the barcode of the holder rack.

Advantageously, the logging means of the device according to the present invention consist of a keyboard and/or a mouse.

Preferably, the memory means and the correlating means of the device according to the invention comprise a microprocessor, a computer case, a computer memory and software.

Optimally, the display means of the device according to the invention consist of a screen.

In a more specific context, the device according to the invention also has automated sampling means for taking a sample from a primary holder and transferring it to a secondary holder, likewise provided with a barcode, the correlation between the primary holders, the secondary holders and/or the holder racks being carried out by the barcode-reading means of the secondary holders and by the logging means, the memory means and/or the correlating means of said device.

Even more specifically, the secondary holders are arranged for example in a second holder rack provided with a plurality of receptacles for receiving in each case one of said secondary holders.

Alternatively, the primary holders are arranged in one row of a holder rack having at least two rows and the secondary holders are arranged in another row of the same holder rack.

More particularly, the automated sampling means are pipetting means.

In this particular context, the automation of the pipetting stage also allows any human error in the reading and/or the allocating of the barcodes to the primary and secondary holders to be avoided. Moreover, any pipetting error, be it in terms of volume or handling, is avoided by the implementation of the means of the device.

The invention will be better understood by reading the detailed description given hereinbelow with reference to the drawings, in which:

The single FIGURE shows a device according to the invention having automated pipetting means.

In the FIGURE, an integrated and/or automated device for locating and/or tracking specimen holders (1) for medical or veterinary primary samples is shown, comprising at least one holder rack (2) provided with a plurality of receptacles for receiving in each case one of said holders (1), each of said holders (1) being provided with a barcode (3).

Thus, typically here within the context of the example shown, the holder racks (2) can be removed and taken away in order to be stored as they are, for example in a serum bank.

This device comprises a barcode (3) reader (5) and, connected thereto, a detector (4) detecting the presence of said holders (1) in the corresponding receptacle.

The device is arranged so as to contain, by way of means (6) for logging the references of the sample contained in the holders, an alphanumeric keyboard such as that of a computer or typewriter.

The device also comprises a computer case (8), a microprocessor (9) and a memory area (7), these elements allowing software to be run for correlating the data read by the barcode reader with the data logged by the keyboard (6).

A mouse (6) is provided so as to be able to interact with the software and, if need be, to start or stop the software and/or a software stage.

All of the data read and/or logged and the progress of the software and of the functioning of the device are displayed with the aid of a screen (10) behind the keyboard (6). Alternatively, the screen (10) and the keyboard (6) can be arranged at a distance from the device itself so as to give the operator the freedom to control the device from his office. In this case, the device is at its most compact.

The device shown has, moreover, an automated pipetting device (12) for taking a sample from a primary holder (1) and transferring it to a secondary holder (13).

1. An integrated and/or automated device for locating and/or tracking specimen holders (1) for medical or veterinary primary samples, comprising at least one holder rack (2) provided with a plurality of receptacles for receiving in each case one of said holders (1), each of said holders (1) being provided with a barcode (3), characterized in that it has at least the following means:
means (4) for detecting the presence of said holders in the corresponding receptacle;
means (5) for reading the barcodes (3) of the holders (1);
means (6) for logging the references of the sample contained in the holders (1);
means (7) for storing the information read and/or logged in a memory;
means (8) for correlating the information read and logged for an identical holder (1);
means (9) for controlling the management and running of the detection means (4), the reading means (5), the logging means (6), the memory means (7) and/or the correlating means (8); and
display means (10).

2. The device as claimed in claim 1, characterized in that the receptacles of each holder rack (2) are arranged in at least one row.

3. The device as claimed in claim 2, characterized in that the receptacles of a holder rack (2) having more than one row are arranged in staggered rows facing the means (5) for reading the barcodes (3).

4. The device as claimed in claim 1, characterized in that the means (5) for reading the barcodes (3) of the holders (1) are arranged parallel to the holders (1) and in that windows (11) are formed such that reading can only take place at predetermined positions corresponding to said receptacles.

5. The device as claimed in claim 1, characterized in that the holder racks (2) can be moved and/or removed.

6. The device as claimed in claim 1, characterized in that the holder rack (2) has a barcode which references it and in that the correlation between the primary holders and the holder rack (2) is carried out by the logging means (6), the memory means (7) and/or the correlating means (8) of said device.

7. The device as claimed in claim 6, characterized in that it also has a dedicated barcode reader for reading the barcode of the holder rack.

8. The device as claimed in claim 1, characterized in that the logging means (6) consist of a keyboard and/or a mouse.

9. The device as claimed in claim 1, characterized in that the memory means (7) and the correlating means (8) of said device comprise a microprocessor, a computer case, a computer memory and software.

10. The device as claimed in claim 1, characterized in that the display means (10) consist of a screen.

11. The device as claimed in claim 1, characterized in that it also has automated sampling means (12) for taking a sample from a primary holder (1) and transferring it to a secondary holder (13), likewise provided with a barcode, the correlation between the primary holders (1), the secondary holders (13) and/or the holder racks being carried out by the barcode-reading means of the secondary holders (13) and by the logging means (6), the memory means (7) and/or the correlating means (8) of said device.

12. The device as claimed in claim 11, characterized in that the secondary holders (13) are arranged in a second holder rack (14) provided with a plurality of receptacles for receiving in each case one of said secondary holders (13).

13. The device as claimed in claim 11, characterized in that the primary holders (1) are arranged in one row of a holder rack (2) having at least two rows and the secondary holders (13) are arranged in another row of the same holder rack (2).

14. The device as claimed in claim 11, characterized in that the automated sampling means (12) are pipetting means.
